(19) United States
(12) Patent Application Publication
(10) Pub. No.: US 2011/0254803 A1
(43) Pub. Date: Oct. 20, 2011

(54) METHOD FOR RECOGNIZING MULTI-TOUCH OF RESISTIVE TOUCH SCREEN

(76) Inventors: Kyoung Soo CHAE, Gyunggi-do (KR); Hee Bum Lee, Gyunggi-do (KR); Yun Ki Hong, Gyunggi-do (KR); Yong Soo Oh, Gyunggi-do (KR); Jong Young Lee, Gyunggi-do (KR)

(21) Appl. No.: 12/818,013

(22) Filed: Jun. 17, 2010

(30) Foreign Application Priority Data
Apr. 20, 2010 (KR) 10-2010-0036540

(51) Int. Cl. G06F 3/045

(52) U.S. Cl. 345/174

(57) ABSTRACT

Disclosed herein is a method for recognizing a resistive touch screen. The method for recognizing the resistive touch screen includes: sensing touch generated at the resistive touch screen; calculating a difference value, a searching value by detecting voltage at two electrode wirings connected with a transparent resistive layer of the resistive touch screen; and comparing the searching value with a reference value that is a difference value between voltages detected at the two electrode wirings when the resistive touch screen is single-touched, whereby the single touch and the multi-touch can be differentiated.

Further, the embodiment sets the error range in the single touch and the error range in the multi-touch and compares these error ranges, thereby making it possible to more accurately differentiate the multi-touch and the single touch and provides various input information, thereby making it possible to provide various user interfaces.

### CROSS REFERENCE TO RELATED APPLICATION

This application claims the benefit of Korean Patent Application No. 10-2010-0036540, filed on Apr. 20, 2010, entitled “Method for Recognizing Multi-Touch Of Resistive Touch Screen”, which is hereby incorporated by reference in its entirety into this application.

### BACKGROUND OF THE INVENTION

1. Technical Field

The present invention relates to a method for recognizing multi-touch of a resistive touch screen.

2. Description of the Related Art

With the development of mobile communication technology, user terminals such as cellular phones, PDAs, navigational devices can serve as a display unit that simply displays character information as well as a unit for providing various and complex multi-media such as audio, moving pictures, radio internet, web browser, etc.

The terminals require a larger display screen, such that a display type using a touch screen has become the main focus. The touch screen has an advantage of saving space of the terminal by integrating a screen and a coordinate input unit, as compared to a key input type according to a prior art.

The touch screen is generally classified into a resistive type and a capacitive type. The resistive touch screen according to a prior art has two substrates disposed to be spaced from each other and a resistive layer formed at an opposite surfaces, respectively. When the resistive layer is touched by external pressure, the change in voltage is measured and the touched coordinates are calculated based on the change in voltage. However, there is a problem in that it is difficult for the resistive touch screen to recognize multi-touch according to a prior art.

Research on a user interface using the multi-touch has been actively conducted. As a result, a capacitive type touch screen capable of recognizing multi-touch has been interested.

However, there are disadvantages in that the capacitive type touch screen is manufacture at high cost, has a limited screen size, and can recognize only the finger (conductive material) touch.

### SUMMARY OF THE INVENTION

The present invention has been made in an effort to provide a method for recognizing multi-touch differentiated from a single touch in a resistive touch screen to be able to be manufactured at low cost without limiting a screen size.

A method for recognizing multi-touch of a resistive touch screen according to a preferred embodiment of the present invention includes: sensing touch generated at a resistive touch screen; calculating a difference value, a searching value by detecting voltage at two electrode wirings connected with a transparent resistive layer of the resistive touch screen; and comparing the searching value with a single touch reference value.

The method for recognizing multi-touch of a resistive touch screen further includes outputting single touch signals if it is determined that the searching value is in the range of the single touch reference value.

The method for recognizing multi-touch of a resistive touch screen further includes outputting multi-touch signals if it is determined that the searching value is out of the single touch reference value range.

The sensing the touch is performed by the change in voltage at the electrode wirings connected with a second transparent resistive layer that is disposed to be opposite to a first transparent resistive layer applied with voltage of the resistive touch screen.

The calculating the searching value includes: detecting voltages between the first electrode wiring and the second electrode wiring connected with the second transparent resistive layer that is disposed to be opposite to the first transparent resistive layer applied with voltage of the resistive touch screen; and calculating the difference value between voltage detected at the first electrode wiring and voltage detected at the second electrode wiring.

### BRIEF DESCRIPTION OF THE DRAWINGS

FIG. 1 is an exploded perspective view schematically showing a resistive touch screen according to the present invention;

FIG. 2 is a block diagram schematically showing a configuration of a touch screen of the present invention;

FIG. 3 is a flow chart showing a process of recognizing single touch and multi-touch;

FIG. 4 is a diagram schematically showing an equivalent circuit of the touch screen on which the touch is not generated;

FIG. 5 is a diagram schematically showing an equivalent circuit of the touch screen in the single touch; and

FIG. 6 is a diagram schematically showing an equivalent circuit of the touch screen in the multi-touch.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the subject of the present invention.

Hereinafter, preferred embodiments of the present invention will be described in detail with reference to the accompanying drawings.

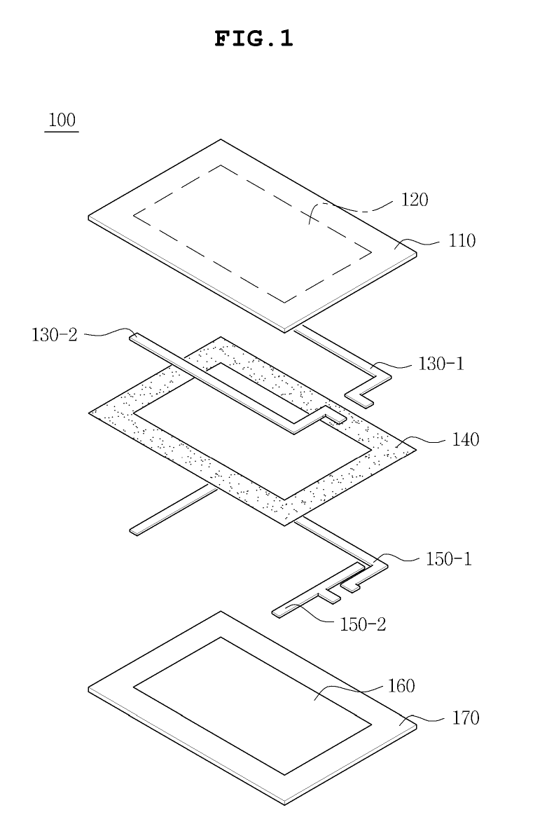

FIG. 1 is an exploded perspective view schematically showing a resistive touch screen according to the present invention. Hereinafter, a method for manufacturing a resistive touch screen according to the present invention will be described with reference to FIG. 1.

The resistive touch screen 100 (hereinafter, touch screen) according to the present invention includes an upper substrate 110 and a lower substrate 170 disposed to be opposite thereto.

An upper transparent resistive layer 120 that has uniform thickness and made of indium tin oxide (ITO), tin oxide (SnO₂), indium oxide (In₂O₃), conductive polymer film, etc., is patterned on the lower surface (surface opposite to the lower substrate 170) of the upper substrate 110.

As the upper substrate 110, a glass substrate, a film substrate, a fiber substrate, a paper substrate, and etc., which are a transparent member, may be used. Among those, the film substrate may be made of polyethyleneterephthalate (PET), polymethylmetacrylate (PMMA), polypropylene (PP), polyethylene (PE), polyethylenenaphthalenedicarboxylate (PEN), polycarbonate (PC), polyethersulfone (PES), polyimide (PI), polyvinylalcohol (PVA), cyclic olefin copolymer (COC), styrene polymer, polyethylene, polypropylene, etc., but is not particularly limited thereto.

The conductive polymer forming the upper transparent resistive layer 120 may be made of polythiophene, polypyrrole, polyaniline, polyacetylene, polypheylene, etc., as organic compounds. In particular, PEDOT/PSS compound among the polythiophene-based organic compounds are most preferable and one or more mixture among the organic-based compounds may be used. Further, when carbon nanotubes, etc., is further added to the organic compounds, conductivity may be further increased.

The upper electrode wirings 130-1 and 130-2 made of metal (for example, silver, copper) are printed in an X-direction to be conducted with the upper transparent resistive layer 120.

Similarly, the lower transparent resistive layer 160 is patterned on an opposite surface of the lower substrate 170 separated by a spacer 140 formed of electrical insulator and lower electrode wirings 150-1 and 150-2 are printed in a Y direction to be conducted with the lower transparent resistive layer 160.

The distal ends of the upper electrode wirings 130-1 and 130-2 and the lower electrode wirings 150-1 and 150-2 are disposed to be gathered at any edges (connection units) of the upper substrate 110 and the lower substrate 170 and are connected to a microprocessor (not shown) by an FPCB (not shown) in this region. In addition, it may include an ADC that converts analog signals into digital signals.

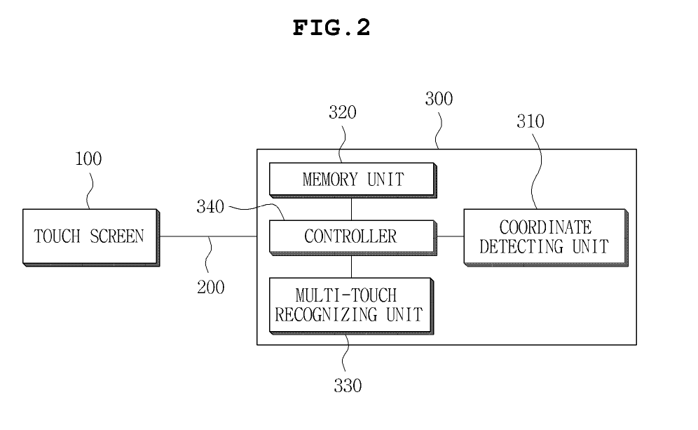

FIG. 2 is a block diagram schematically showing a configuration of a touch screen according to the present invention. As shown in FIG. 2, the touch screen 100 is connected to a microprocessor 300 through an FPCB 200.

The touch screen 100 outputs the changed voltage when the upper transparent resistive layer and the lower transparent resistive layer contact each other by external pressure. Voltage from the touch screen 100 is transferred to the microprocessor 300 and the microprocessor 300 detects voltage output from the touch screen to differentiate single touch from multi-touch. At this time, the voltage output from the touch screen may be applied to the microprocessor 300 as the digital signal via the ADC.

The microprocessor 300 differentiates whether touch generated on the touch screen 100 is the single touch or the multi-touch and transfers single touch signals or multi-touch signals to a display unit. The display unit receiving signals provides menus or images corresponding to the single touch or the multi-touch to a user.

The microprocessor 300 includes a coordinate detector 310, a memory unit 320, a multi-touch recognizing unit 330, and a controller 340. The functions of the components configuring the microprocessor 300 describe the multi-touch recognizing method of the touch screen 100 and these components will be described below.

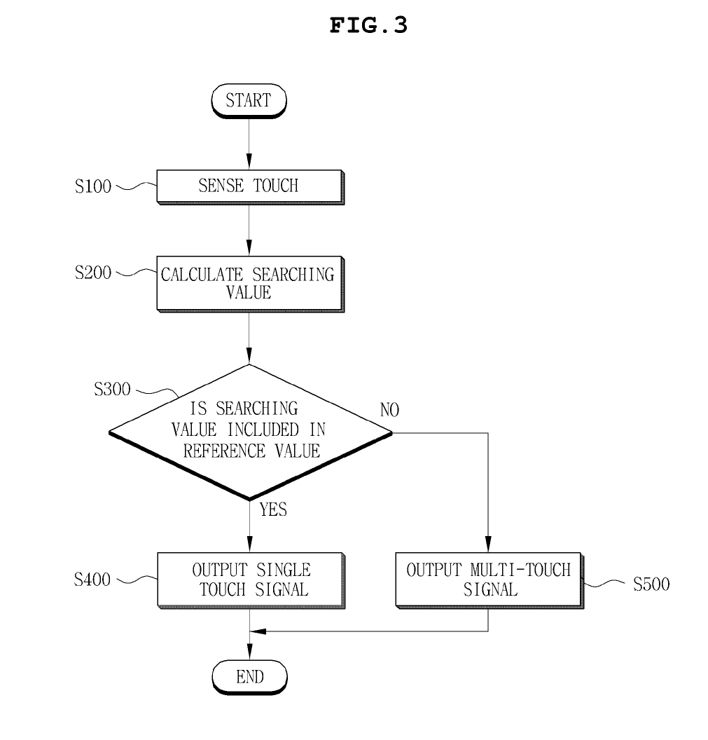

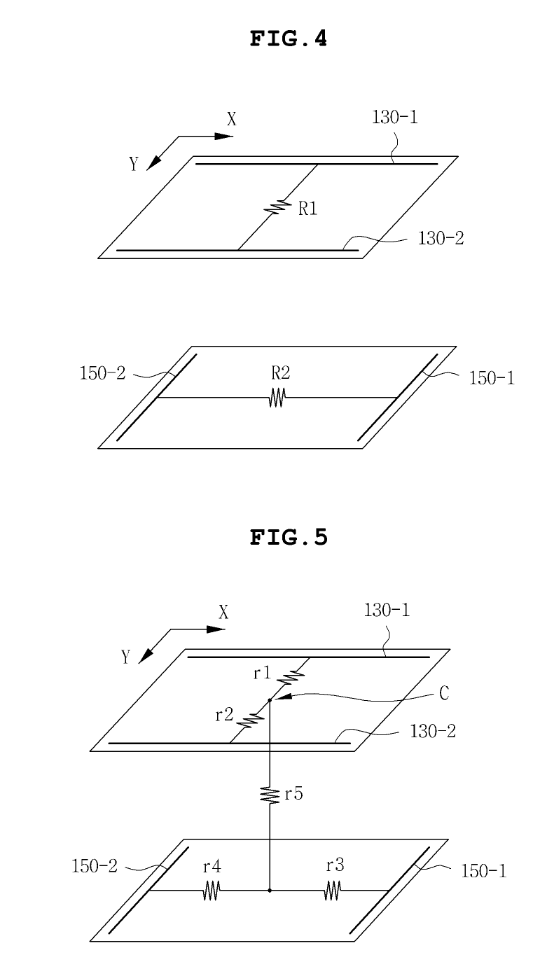

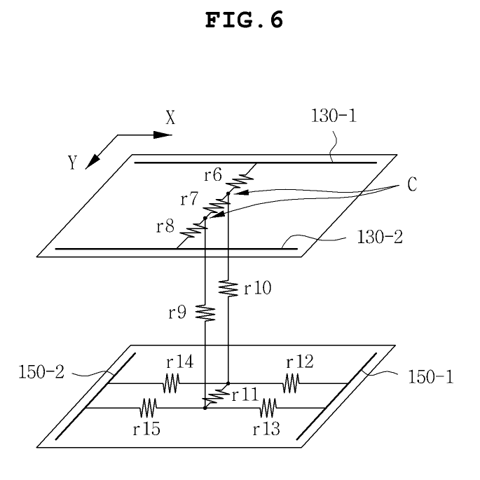

FIG. 3 is a flow chart showing a process of recognizing single touch and multi-touch, FIG. 4 is a diagram schematically showing an equivalent circuit of the touch screen on which the touch is not generated, FIG. 5 is a diagram schematically showing an equivalent circuit of the touch screen in the single touch, and FIG. 6 is a diagram schematically showing an equivalent circuit of the touch screen in the multi-touch.

Hereinafter, a method for recognizing multi-touch of a resistive touch screen according to the present invention will be described with reference to FIGS. 3 to 6.

As shown in FIG. 3, in the resistive touch screen, touch generated on the touch screen is detected in order to recognize the multi-touch and the single touch in the resistive touch screen (S100).

At this time, the change in voltage generated on the transparent resistive layer is detected by the coordinate detector 310 of the microprocessor 300. The coordinate detector 310 detects the change in voltage from the electrode wirings connected to the second transparent resistive layer that is disposed to be opposite to the first transparent resistive layer to which the voltage of the resistive touch screen is applied and if there is no change in voltage, determines that the touch is not generated and if there is the change in voltage, determines that the touch is generated. The first transparent resistive layer is a resistive layer applied with voltage and may be any one of the upper transparent resistive layer and the upper transparent resistive layer. Therefore, the structure of the touch screen is not limited.

As shown in FIG. 4, the upper transparent resistive layer 120 and the lower transparent resistive layer 160 each have resistive components R1 and R2 before the touch screen 100 is touched. Generally, since the touch screen 100 is driven in the state where direct voltage is applied to the upper transparent resistive layer 120 and the lower transparent resistive layer 160, respectively, the transparent resistive layer is treated as resistance components having a predetermined size before the touch is generated. Therefore, the change in voltage is not generated before the touch is generated.

However, as shown in FIG. 5, when the touch is generated at one point, the upper transparent resistive layer 120 and the lower resistive layer 160 each are divided into two resistance components (r1 and r2; r3 and r4) and another resistance component r5 is generated at a contact point C between the upper transparent resistive layer 120 and the lower transparent resistive layer 160.

Unlike the upper transparent resistive layer 120 and the lower transparent resistive layer 160 each having the resistance components R1 and R2 before the touch is generated, they are divided into a plurality of resistance components r1, r2, r3, r4, and r5 having a small size and are connected with each other in parallel after the touch is generated, such that voltage measured at the electrode wiring is different from the voltage before the touch is generated. This may be identically applied to the multi-touch where the touch is generated at two or more points.

Even though the coordinate detector 310 detects the change in voltage only in any one of two electrode wirings connected with the transparent resistive layer that is disposed to be opposite to the transparent resistive layer applied with voltage according to the above-mentioned principle, the touch generated on the touch screen can be detected.

The coordinate detector 310 detects the touch generated on the touch screen as well as the coordinates of the contact point C. This is performed when the touch generated on the touch screen is determined as the single touch. The coordinate detecting method will be described below.

As shown in FIG. 3, when the touch is detected on the touch screen 100, voltages are detected at two electrode wirings connected with the transparent resistive layer of the touch screen 100 and the difference values between the voltages, that is, the searching value are calculated (S200).

This is performed by a multi-touch recognizing unit 330 of the microprocessor 300 and voltage is measured at two electrode wirings connected with the transparent resistive layer that is disposed to be opposite to the transparent resistive layer applied with voltage. For example, voltage is measured at the first lower electrode wiring and the second lower electrode wiring connected with the lower transparent resistive layer that is disposed to be opposite to the upper transparent resistive layer 120 applied with voltage.

When the single touch is generated, voltage measured at the first lower electrode wiring 150-1 and the second lower electrode wiring 150-2 may be affected by internal resistance of the electrode wirings, such that the same or approximately the same value is detected.

However, when the multi-touch is generated, different voltage value is detected at two electrode wirings. For example, as shown in HG 6, when two points touch, three resistive components r6, r7, and r8 are generated on the upper transparent resistive layer 120, one resistive component r11 is generated on the lower transparent resistive layer 160, with the contact point therebetween, two resistive components r9 and r10 are generated between the transparent resistive layers 120 and 160, and a plurality of resistive components r11 to r15 are generated between the contact point C and the lower electrode wirings 150-1 and 150-2, such that very different voltage value is detected at the first lower electrode wiring 150-1 and the second lower electrode wiring 150-2.

The multi-touch recognizing unit 330 calculates the difference value between voltages detected at two electrode wirings. At this time, the voltages measured at two electrode wirings may have different values due to the resistance arrangement changed by the contact point and the difference between the internal resistances of the electrode wirings. In the specification, the difference value is called as the searching value.

In the case of the single touch, the searching value is 0 or approximates 0 and becomes a variable value having a narrow absolute value range and in the case of the multi-touch, the searching value becomes a variable value having a wide absolute value range without overlapping with the searching value of the single touch.

When the searching value is calculated, the above-mentioned searching value is compared with the single touch reference value as shown in FIG. 3 (S300).

At this time, the single touch reference value is stored in the memory unit 320 of the microprocessor 300. The single touch reference value is the difference value measured at the first electrode wiring and the second electrode wiring connected with the second transparent electrode layer that is disposed to be opposite to the first transparent electrode layer applied with voltage when the single touch is generated on the touch screen and has a slightly wider range than the difference value of voltage substantially generated as the absolute value of the difference value measured at two electrode wirings. In other words, the single touch reference value has slightly wider value than the searching value when the single touch is substantially generated on the touch screen.

Therefore, the multi-touch recognizing unit 330 is determined as the single touch when the calculated searching value is included in the single touch reference value stored in the memory unit 320 and is determined as the multi-touch when the calculated searching value is outside of the single touch reference value.

If it is determined as the single touch, the controller 340 outputs the single touch signals as shown in FIG. 3 (S400). The single touch signal may include the coordinate information of the contact point C.

The coordinate information is detected by alternately applying direct voltage to the upper transparent resistive layer or the lower transparent resistive layer and measuring voltage at the electrode wirings connected with the transparent resistive layer that is disposed to be opposite to the transparent resistive layer applied direct voltage.

Referring back to FIG. 5, the upper transparent resistive layer 120 applied with direct voltage is divided into two resistive components r1 and r2 and the coordinate recognizing unit 310 detects voltage through the lower electrode wiring connected with the lower transparent resistive layer 160. The voltage represents voltage in a Y direction of the touch screen. The coordinate recognizing unit 310 acquires a Y coordinate based on the coordinate information according to the voltage stored in the memory unit 320. The X coordinate is acquired by applying direct voltage to the lower transparent resistive layer 160 and detecting voltage at the upper electrode wirings 130-1 and 130-2.

The terminal in which the resistive touch screen is mounted receives the single touch signals to select icons positioned at the corresponding coordinates or perform the corresponding functions by interconnecting with the display unit.

If it is determined as the multi-touch, the controller 340 outputs the multi-touch signals as shown in FIG. 3 (S500). The terminal receives the multi-touch signals to expand or reduce images displayed on the display unit. The expanding or reducing functions are determined based on the change in voltage detected on the touch screen. In other words, when voltage output from the multi-touch signals becomes large, it is determined that the interval between the touched points is increased, such that the expanding function can be performed, while when voltage becomes small, it is determined that the interval between the touched points is reduced, such that the reducing function can be performed.

According to the present invention, the single touch and the multi-touch can be differentiated in the resistive touch screen.

Further, according to the present invention, the error range in the single touch and the error range in the multi-touch are set and these error ranges are compared, thereby making it possible to more accurately differentiate the multi-touch.

In addition, according to the present invention, various input information is provided by differentiating the multi-touch, thereby making it possible to provide the various user interfaces.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A method for recognizing multi-touch of a resistive touch screen, comprising:
sensing touch generated at the resistive touch screen;
calculating a difference value, a searching value by detecting voltage at two electrode wirings connected with a transparent resistive layer of the resistive touch screen; and
comparing the searching value with a single touch reference value.

2. The method for recognizing multi-touch of a resistive touch screen as set forth in claim 1, further comprising outputting single touch signals if it is determined that the searching value is in the range of the single touch reference value.

3. The method for recognizing multi-touch of a resistive touch screen as set forth in claim 1, further comprising outputting multi-touch signals if it is determined that the searching value is out of the single touch reference value range.

4. The method for recognizing multi-touch of a resistive touch screen as set forth in claim 1, wherein the sensing the touch is performed by the change in value at the electrode wirings connected with a second transparent resistive layer that is disposed to be opposite to a first transparent resistive layer applied with voltage of the resistive touch screen.

5. The method for recognizing multi-touch of a resistive touch screen as set forth in claim 1, wherein the calculating the searching value includes:
detecting voltages between the first electrode wiring and the second electrode wiring connected with the second transparent resistive layer that is disposed to be opposite to the first transparent resistive layer applied with voltage of the resistive touch screen; and
calculating the difference value between voltage detected at the first electrode wiring and voltage detected at the second electrode wiring.
